(19) United States
(12) Patent Application Publication
(10) Pub. No.: US 2025/0136413 A1
(43) Pub. Date: May 1, 2025

(54) METHOD AND APPARATUS FOR DETECTING AUTOMATIC CLOSING FUNCTION OF A FLOOR DOOR IN AN ELEVATOR SYSTEM

(71) Applicant: Otis Elevator Company, Farmington, CT (US)

(72) Inventors: Qing Wu, Shanghai (CN); Xiaobin Tang, Tianjin (CN)

(21) Appl. No.: 18/919,535

(22) Filed: Oct. 18, 2024

(30) Foreign Application Priority Data
Oct. 26, 2023 (CN) 202311407013.6

(51) Int. Cl. B66B 13/14; B66B 1/34

(52) U.S. Cl. CPC B66B 13/146; B66B 1/3461

(57) ABSTRACT

A method and device for detecting a function of an elevator system, an elevator system including the device, and a non-transitory computer-readable storage medium storing a computer program for implementing the method. In the method for detecting an automatic closing function of a landing door, when a car of the elevator system stops at one of a plurality of floors, a car door of the car and a landing door associated with one of the plurality of floors are opened. Subsequently, a closing process of the car door and the landing door is initiated by causing a drive mechanism of the elevator system to apply a driving force to the car door. Subsequently, when a gap of the car door or the landing door decreases to a preset value, causing the drive mechanism to stop applying the driving force to the car door.

### FOREIGN PRIORITY

This application claims priority to Chinese Patent Application No. 202311407013.6, filed Oct. 26, 2023, and all the benefits accruing therefrom under 35 U.S.C. § 119, the contents of which in its entirety are herein incorporated by reference.

### TECHNICAL FIELD OF INVENTION

The present application relates to elevator maintenance technology and, in particular, to a method and device for detecting an automatic closing function of a landing door of an elevator system, an elevator system comprising the device, and a non-transitory computer-readable storage medium storing a computer program for implementing the method.

### BACKGROUND OF THE INVENTION

When an elevator car is running or a landing door is not properly closed, the landing door will be locked automatically with the help of the self-locking function to reduce the risk of accidents. Currently, the check of an automatic closing function of a landing door is still manually completed. For example, maintenance personnel regularly or irregularly test the self-locking function of the landing door on each floor one by one to determine whether its function is normal. The check work will take a large amount of labor and time, especially for elevator systems operating in high-rise and ultra-high-rise buildings.

### SUMMARY OF THE INVENTION

In accordance with an aspect of the present application, there is provided a method for detecting an automatic closing function of a landing door of an elevator system. In the method, when a car of the elevator system stops at one of a plurality of floors, a car door of the car and a landing door associated with one of the plurality of floors are opened. Subsequently, a closing process of the car door and the landing door is initiated by causing a drive mechanism of the elevator system to apply a driving force to the car door. Subsequently, when a gap of the car door or the landing door decreases to a preset value, causing the drive mechanism to stop applying the driving force to the car door. Next, it is determined whether the landing door associated with one of the plurality of floors is closed normally within a preset time period since the stopping of applying the driving force to the car door.

Optionally, in the method, the above steps are performed in a specified order for landing doors associated with other floors of the plurality of floors.

Optionally, in the method, further comprising: determining whether the elevator system is adapted to enter or be in a test mode, and if so, performing the above steps.

Optionally, in the method, further sending a test report on the automatic closing function of the landing door to cloud or a mobile terminal.

Optionally, in the method, the gap is achieved to the preset value by controlling a duration of the driving force applied by the drive mechanism to the car door.

Optionally, in the method, the preset value satisfies the following conditions: after the gap of the car door or the landing door associated with one of the plurality of floors decreases to the preset value, even if the driving force applied to the car door is stopped, the landing door associated with one of the plurality of floors is still capable of being closed normally when the automatic closing function of the landing door is normal.

Optionally, in the method, the preset time period is determined based on experimental data of a closing operation of the landing door.

Optionally, in the method, the preset time period is determined in the following manner:

if the driving force or a speed of the car or a speed of the landing door associated with one of the plurality of floors is greater than or equal to a preset threshold, the preset time period is corrected using an inverse function of a Sigmoid function as a correction function.

Optionally, in the method, a door closing in place signal from the elevator system is used to determine whether the landing door associated with one of the plurality of floors is closed normally.

In accordance with another aspect of the present application, there is also provided a device for detecting an automatic closing function of a landing door of an elevator system. The device comprises a memory, a processor coupled with the memory, and a computer program stored on the memory and running on the processor. The running of the computer program results in the following operations: opening a car door of the car and a landing door associated with one of the plurality of floors when a car of the elevator system stops at one of a plurality of floors; initiating a closing process of the car door and the landing door by applying a driving force to the car door by a drive mechanism of the elevator system; causing the drive mechanism to stop applying the driving force to the car door when a gap of the car door or a gap of the landing door decreases to a preset value; and determining whether the landing door can be closed normally within a preset time period since the stopping of applying the driving force to the car door.

In accordance with a further aspect of the present application, there is further provided an elevator system comprising landing doors provided at a plurality of floors, a car, a drive mechanism and an elevator controller. The landing door has an automatic closing function of a landing door. The elevator controller comprises a memory, a processor coupled with the memory, and a computer program stored on the memory and running on the processor. The running of the computer program results in the following operations: opening a car door of the car and a landing door associated with one of the plurality of floors when a car of the elevator system stops at one of a plurality of floors; initiating a closing process of the car door and the landing door by applying a driving force to the car door by a drive mechanism of the elevator system; causing the drive mechanism to stop applying the driving force to the car door when a gap of the car door or a gap of the landing door decreases to a preset value; and determining whether the landing door can be closed normally within a preset time period since the stopping of applying the driving force to the car door.

In accordance with a further aspect of the present application, there is provided a computer-readable storage medium on which a computer program suitable for running on a processor of a terminal device is stored, the running of the computer program resulting in the steps of the method as described above being performed.

### BRIEF DESCRIPTION OF THE DRAWINGS

The above and/or other aspects and advantages of the present application will be clearer and more easily understood from the following description of various aspects in conjunction with the accompanying drawings, in which the same or similar units are denoted by the same reference numerals. The accompanying drawings include:

FIG. 1 is a flowchart of a method for detecting an automatic closing function of a landing door of an elevator system in accordance with some embodiments of the present application.

FIGS. 2A-2D are schematic diagrams of states of a car door and a landing door of an elevator system.

FIG. 3 is a schematic block diagram of a device or detection device for detecting an automatic closing function of a landing door of an elevator system in accordance with some other embodiments of the present application.

FIG. 4 is a schematic block diagram of an elevator system in accordance with some other embodiments of the present application.

### DETAILED DESCRIPTION OF THE INVENTION

The present application is described more fully below with reference to the accompanying drawings, in which illustrative embodiments of the application are illustrated. However, the present application may be implemented in different forms and should not be construed as limited to the embodiments presented herein. The presented embodiments are intended to make the disclosure herein comprehensive and complete, so as to more comprehensively convey the protection scope of the application to those skilled in the art.

In this specification, terms such as “comprising” and “including” mean that in addition to units and steps that are directly and clearly stated in the specification and claims, the technical solution of the application does not exclude the presence of other units and steps that are not directly or clearly stated in the specification and claims.

In this specification, “closing process” refers to a process in which a car door or landing door starts to move and then achieve a closed state or normal closing. During the closing process, the car door or landing door gradually decreases a gap between the doors. The closed state or normal closing described herein means that the car door or landing door is completely closed without gaps or openings. It is noted that the gap described herein may refer to a gap between door bodies (when the door comprises a plurality of door bodies) or a gap between the door body and the door frame (when the door comprises only one door body).

In this specification, “automatic closing function of a landing door” refers to a function that causes the landing door to close, prohibits the opening of the landing door, or locks the landing door when an elevator system is in a specific state (e.g., when the car is in the stopped state and the landing door is completely closed). It should be noted that the implementation of the automatic closing function of the landing door is dependent on a cooperative operation of multiple levels and multiple components. For example, in the case of the landing door of the elevator system, the elevator controller monitors the state of each landing door and the position of the car, and determines the timing of locking the landing door based on the monitoring information; for example, the door sensor or door lock switch is responsible for transmitting the state signal of the landing door (e.g., a door closing in place signal) to the elevator controller; and for example, an executing mechanism is a key component that usually executes actions to close, lock, or unlock the landing door based on instructions from the elevator controller. That is, any abnormal operation of any level or component may lead to abnormal automatic closing function of the landing door.

The specific structure and working principle of the executing mechanism may vary depending on the elevator manufacturer and product model, and it usually includes components such as a spring device and/or a safety gear for ensuring normal operation of the automatic closing function of the landing door. For example, in a typical executing mechanism, when the landing door is in a closed state, the spring will apply a certain force to the landing door to keep it tightly closed. The safety gear is another component of the executing mechanism, which may keep the landing door locked when the car is in a stopped state and the landing door is completely closed. It should be noted that it is usually not necessary to configure a separate safety gear for each landing door; furthermore, a separate spring may be configured for each landing door, or a shared set of spring systems may be used to support multiple landing doors of the elevator system.

In some embodiments of the present application, a check of the automatic closing function of the landing door will be performed by putting the elevator system into a test mode. The check of the automatic closing function of the landing door is described in detail below.

When the elevator system is in the test mode, the car door is driven into a closing process. During the closing process, the landing door moves in the same direction under the drive of the car door. A drive mechanism such as an electric motor or hydraulic system may usually be used to provide the force or driving force used to drive the movement of the car door and the landing door. When the driving force is large enough, it may overcome the resistance to the car door and the landing door (e.g., the friction between the car door and the landing door and the frame) and close. With the movement of the car door and the landing door, the gap of the car door and the gap of the landing door will gradually decrease. When the gap of the car door or the gap of the landing door reaches a preset value (for example, 50 mm), the drive mechanism is caused to stop outputting the driving force. At this time, if the automatic closing function of the landing door is normal, the landing door will continue to move under the action of the executing mechanism until it is completely closed or closed (the car door will move in the same direction under the drive of the landing door). Therefore, it may be determined whether the automatic closing function of the landing door is normal based on the result of whether the landing door is able to close completely or normally (which result may be obtained, for example, by a door closing in place signal).

In some embodiments, the magnitude of the driving force may be selected such that the car door and the landing door move slowly (e.g. at a speed of movement no more than 40 mm/second). It should be noted, however, that this is not a necessary limitation. While the fast speed allows the landing door to enter the closed state in a short period of time, the impact of the speed of movement can be eliminated or suppressed by increasing the preset value of the gap and a preset time period as will be described below.

A variety of means may be used to control the gap of the car door or the landing door. For example, in some embodiments, a sensor may be provided in the vicinity of the car door or the landing door to measure the gap of the car door or the landing door (e.g., a pair of wireless signal transmitter and wireless signal receiver is deployed on the side of the car door or landing door, whereby the gap of the door may be determined based on the signal strength). When the gap reaches the preset value, the output of the driving force is ceased. In other embodiments, the gap of the car door or the landing door may be reached to the preset value by controlling the duration of the drive mechanism providing the driving force to the car door (i.e., a time interval from the beginning of providing the driving force to the end of the output of the driving force).

It should be noted that in many cases, there may be a critical value for the preset value, and in the event that the gap exceeds the critical value, even if the automatic closing function of the landing door is normal, the landing door will not be able to be completely closed once the output of the driving force to the car door stops after the gap of the car door or the landing door reaches the critical value. In some embodiments, the selected preset value may satisfy the following conditions: after the gap of the car door or the landing door decreases to the selected value, even if the output of the driving force stops, the landing door is still capable of being closed normally when the automatic closing function of the landing door is normal.

It is generally recognized that an abnormality in the automatic closing function of the landing door, regardless of the cause, results in the landing door not being able to close completely. However, even if the landing door is able to close completely, it cannot be ruled out that the automatic closing function of the landing door may fail within a short period of time. In order to be able to detect such a potential risk of failure, in some embodiments of the present application, not only attention is paid to the ability of the landing door to be completely closed, but also time is introduced as a dimension to be examined, i.e., it is determined that the automatic closing function of the landing door is normal only if the landing door is able to be completely closed within a preset time period since the drive mechanism stops outputting the driving force.

The above preset time period may be determined based on experimental data of a closing operation of the landing door. For example, in the case where it is confirmed that the automatic closing function of the landing door is normal, the length of time T required for the landing door to enter the closed state corresponding to a plurality of gap values g within a range of values smaller than the above-described critical value is measured to obtain a gap-time correspondence or relationship curve (the relationship curve may be obtained by a fitting operation such as interpolation on the measured values), and the preset time period Δt is obtained from the correspondence or the relationship curve. For example, the time T (gₛₑₜ) corresponding to the preset value gₛₑₜ of the gap may be determined as the preset time period Δt. As another example, the time T (g_{critical}) corresponding to the critical value g_{critical} of the gap may be determined as the preset time period Δt.

As mentioned above, the magnitude of the driving force or the speed of movement of the car door and the landing door will have an impact on the length of time required for the landing door to enter the closed state. In qualitative terms, the greater the driving force or the speed of movement of the car door and the landing door, the shorter the length of time required for the landing door to enter the closed state, and vice versa. In some embodiments, the preset time period may be corrected based on the driving force or the speed of movement. For example, the inventors of the present application have found, after research, that there is usually a threshold value of the driving force or the speed of movement, that the correction of the preset time period is unnecessary when it is smaller than the threshold value, and that using an inverse function of a Sigmoid function as a correction function of the preset time period can effectively eliminate the impact of the driving force or the speed of movement when it exceeds the threshold value. Specifically, the preset time period may be, for example, corrected based on a function of the following form:

$$Δ {t}^{1} = \{ \begin{matrix}\frac{{L}^{Δ t 1}}{1 + esp ( k ( x - {x}_{o} )} , \begin{matrix}X < {X}_{o} \\ X \geq {X}_{o}\end{matrix}\end{matrix} \qquad ( 1 )$$

In the above function, Δt and Δt′ are the preset time period and the correction value of the preset time period, respectively; X is one of the following three: the driving force applied to the car door by the drive mechanism, the speed of movement of the car door, and the speed of movement of the landing door; L, k, and X₀ are constants greater than 0, which may be determined through experiments, where X₀ is the threshold value described above.

The above-described method of checking the automatic closing function of the landing door is not only applicable to a single landing door, but is also applicable to a plurality of landing doors. For example, the automatic closing function of each landing door may be checked sequentially in the order of the list of landing doors to be maintained in accordance with the above-described checking method, and the checking results may be stored, until all the landing doors have completed the checking operation. It is to be noted that the order in which the check is performed may be various specified orders, such as a floor order including landing doors from the 1st floor to the nth floor or landing doors from the nth floor to the 1st floor, or an order obtained by randomly selecting from the landing doors of the 1st to the nth floors. In addition, the above checking method is also applicable in the case where a floor contains a plurality of landing doors, in which case a corresponding device identification may be assigned to each of the landing doors to distinguish the landing doors from each other.

In some embodiments, the stored checking results may be sent to the cloud (e.g., via an IoT gateway to a remote server) or to a mobile terminal (e.g., via a Bluetooth channel or a mobile communication system to a mobile terminal such as a cell phone, a tablet, a portable computer, and a wearable device).

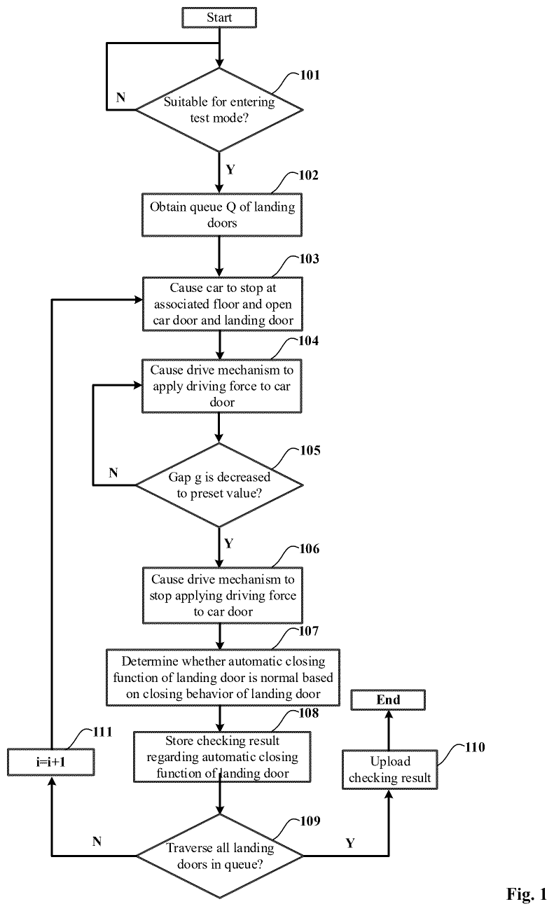

FIG. 1 is a flowchart of a method for detecting an automatic closing function of a landing door of an elevator system in accordance with some embodiments of the present application. The method described below may be implemented by various devices, which include, for example, but are not limited to, a control device or an elevator controller within an elevator system and a dedicated device for detecting the automatic closing function of a landing door, etc., which will be collectively referred to hereinafter as the device for detecting the function of the elevator system or the detection device.

The method shown in FIG. 1 begins at step 101. In this step, the detection device determines whether the elevator system is suitable for entering the test mode at the current time. If it is suitable for entering the test mode, it proceeds to step 102, otherwise, it continues to wait. Exemplarily, maintenance of the elevator system is usually performed during non-operational hours, so the detection device may allow the elevator system to enter the test mode only when the current time is outside of the operational hours and there are no calls for the elevator.

At step 102, the detection device obtains a queue Q of landing doors to be performed for checking the automatic closing function of the landing door, the queue comprises one or more landing doors FDᵢ, each landing door being associated with one of a plurality of floors (e.g., provide at an associated floor). In some embodiments, the order of floors (e.g. from the 1st floor to the nth floor or from the nth floor to the 1st floor) is used as the order in which checks are performed on the landing doors. However, it should be noted that this is not necessary and other checking orders may be used as needed for application scenarios (e.g., performing the checking only for landing doors on even or odd numbered floors, or performing the checking for landing doors that are used frequently). Exemplarily, the serial number i is used to indicate the order in which the checking operation of the automatic closing function of the landing door is performed.

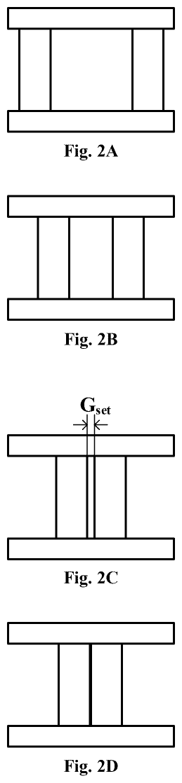

Then proceed to step 103, in which the detection device causes the car to stop at the floor associated with the ith landing door FDᵢ (i=1 when the detection is started) in the queue Q of landing doors, i.e., the car stops stationary at that floor. Optionally, the detection device also causes the landing door and car door to be in an open state, as shown in FIG. 2A.

Next, at step 104, the detection device causes a drive mechanism (e.g., a motor) of the car door CD to apply a driving force f1 to the car door (e.g., by causing a power source to supply power to the drive mechanism), thereby initiating a closing process of the car door and the ith landing door FDᵢ. During this process, the landing door FDᵢ will move in the same direction under the drive of the car door CD, as shown in FIG. 2B. In many cases, the landing door FDᵢ has the same speed of movement as the car door CD. As described above, the magnitude of the driving force or the speed of movement has an impact on the length of time required for the landing door to enter the closed state after that force is withdrawn. In some embodiments, a small driving force or the speed of movement may be used to reduce this impact. In other embodiments, the impact of the driving force or speed of movement on the length of time may be compensated by correcting for a preset time period.

Then proceed to step 105, in which the detection device determines whether the gap g of the car door CD or the landing door FDᵢ is decreased to the preset value gₛₑₜ. If it is decreased to (e.g., as in the case shown in FIG. 2C), proceed to step 106; otherwise, return to step 104. The selection of the preset value has already been described in detail above, and will not be repeated herein.

At step 106, the detection device causes the drive mechanism (e.g., a motor) of the car door CD to stop applying the driving force f1 to the car door (e.g., by causing the power supply to be disconnected from the drive mechanism). Thereafter, the car door CD and the landing door FDᵢ will be further closed by the force f₂ of the executing mechanism, as shown in FIG. 2D.

The process shown in FIG. 1 proceeds to step 107 after step 106. In this step, the detection device determines whether the automatic closing function of the landing door is normal based on the closing behavior of the landing door FDᵢ. Specifically, if the landing door FDᵢ can be closed normally or completely closed within a preset time period since the stopping of applying the driving force to the car door CD, it is determined that the automatic closing function of the landing door FDᵢ is normal, otherwise, it is determined that the automatic closing function of the landing door FDᵢ is abnormal. Exemplarily, it may be determined whether the landing door FDᵢ is closed completely with the aid of the door closing in place signal of the elevator system.

Then proceed to step 108, in which the detection device stores the checking result regarding the automatic closing function of the landing door FDᵢ.

Subsequently, in step 109, the detection device determines whether the checking of the automatic closing function of the landing door has been completed for all landing doors in the queue Q. If all landing doors in the queue Q are traversed, it proceeds to step 110, and otherwise, it proceeds to step 111.

At step 110, the detection device sends the checking results regarding the automatic closing function of each landing door stored in step 108 to the cloud or the mobile terminal.

At step 111, the detection device increments the serial number of the landing door (i=i+1) to cause the operation object of the subsequent step to be updated to the next landing door in the queue Q. After completing step 111, the method flow shown in FIG. 1 returns to step 103 so as to perform the checking operation of the automatic closing function of the landing door for other landing doors in the queue Q.

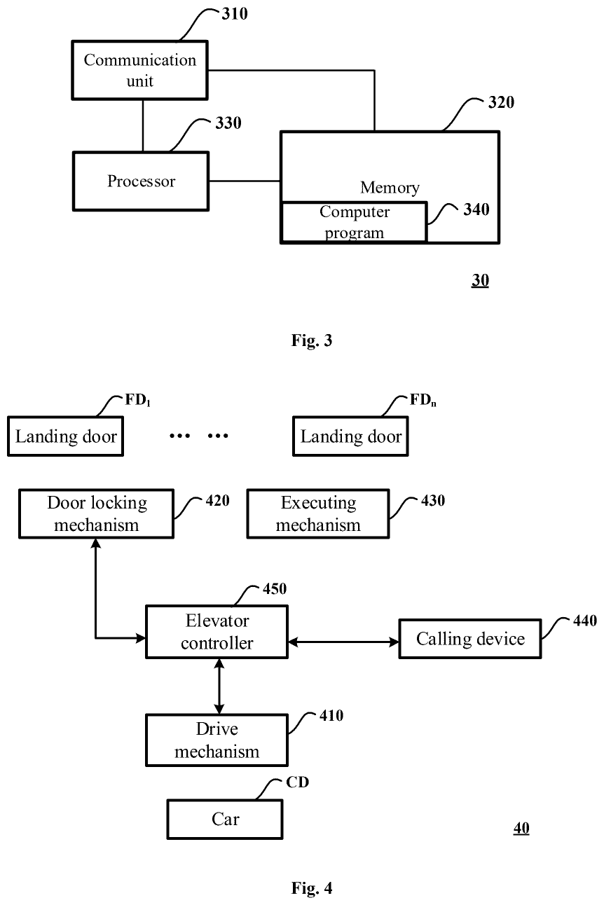

FIG. 3 is a schematic block diagram of a device or detection device for detecting an automatic closing function of a landing door of an elevator system in accordance with some other embodiments of the present application. The detection device shown in FIG. 3 may be used to implement the method shown in FIG. 1.

As shown in FIG. 3, a detection device 30 comprises a communication unit 310, a memory 320 (e.g., a non-volatile memory such as a flash memory, a ROM, a hard drive, a disk, an optical disc), a processor 330, and a computer program 340.

The communication unit 310 serves as a communication interface configured to establish a communication connection between the detection device and an external device (e.g., a drive mechanism of a car door, a door lock switch, etc.) or a network (e.g., Internet and a wireless local area network, etc.).

The memory 320 stores the computer program 340 that may be executed by the processor 330. In addition, the memory 320 may store data generated by the processor 330 in execution of the computer program 340 and data received from the external device via the communication unit 310 (e.g., a queue Q of landing doors to be performed for checking the automatic closing function of the landing door and a checking result regarding the automatic closing function of the landing door, etc.).

The processor 330 is configured to run the computer program 340 stored on the memory 320 and to perform access operations to the memory 320 (e.g., obtaining the queue Q of landing doors and storing the checking result regarding the automatic closing function of the landing door in the memory 320).

The computer program 340 may include computer instructions for implementing a method described with the aid of FIG. 1, enabling implementation of the corresponding method when the computer program 340 is run on the processor 330.

FIG. 4 is a schematic block diagram of an elevator system in accordance with some other embodiments of the present application.

An elevator system 40 shown in FIG. 4 includes landing doors FD₁ to FDₙ provided at a plurality of floors having an automatic closing function of a landing door, a car CD, a drive mechanism 410 (e.g., a motor and sheave at the top of a hoistway) for driving the movement of the car, a door locking mechanism 420 (e.g., a door interlock), an executing mechanism 430 (e.g., a door close motor) for implementing the automatic closing function of the landing door, a calling device 440 (e.g., a hall call or destination call entry), and an elevator controller 450 (e.g., a processor-based controller programed to perform the operations described herein).

Referring to FIG. 4, the elevator controller 450 is coupled with the drive mechanism 410, the door locking mechanism 420, and the calling device 440, and is configured to receive a calling request from the calling device 440 and generate a corresponding control command (e.g., commanding the car to stop at a specified floor, etc.) in response to the calling request. The elevator controller 450 may have one or more features of the detection device shown in FIG. 3 so as to perform the checking operation of the automatic closing function of the landing door described in detail above.

Those skilled in the art will appreciate that various illustrative logical blocks, modules, circuits, and algorithm steps described herein may be implemented as electronic hardware, computer software, or combinations of both.

To demonstrate this interchangeability between the hardware and software, various illustrative components, blocks, modules, circuits, and steps have been described above generally in terms of their functionality. Whether such functionality is implemented in hardware or software depends on the particular application and design constraints imposed on the overall system. Those skilled in the art may implement the described functionality in changing ways for the particular application. However, such implementation decisions should not be interpreted as causing a departure from the scope of the present application.

Although only a few of the specific embodiments of the present application have been described, those skilled in the art will appreciate that the present application may be embodied in many other forms without departing from the spirit and scope thereof. Accordingly, the examples and implementations shown are to be regarded as illustrative and not restrictive, and various modifications and substitutions may be covered by the application without departing from the spirit and scope of the application as defined by the appended claims.

The embodiments and examples presented herein are provided to best illustrate embodiments in accordance with the present technology and its particular application, and to thereby enable those skilled in the art to implement and use the present application. However, those skilled in the art will appreciate that the above description and examples are provided for convenience of illustration and example only. The presented description is not intended to cover every aspect of the application or to limit the application to the precise form disclosed.

What is claimed is:

1. A method for detecting an automatic closing function of a landing door of an elevator system, the method comprising:
A. when a car of the elevator system stops at one of a plurality of floors, opening a car door of the car and a landing door associated with one of the plurality of floors;
B. initiating a closing process of the car door and the landing door by applying a driving force to the car door by a drive mechanism of the elevator system;
C. causing the drive mechanism to stop applying the driving force to the car door when a gap of the car door or a gap of the landing door decreases to a preset value; and
D. determining whether the landing door can be closed normally within a preset time period since the stopping of applying the driving force to the car door.

2. The method of claim 1, further comprising: performing steps A to D in a specified order for landing doors associated with other floors of the plurality of floors.

3. The method of claim 1, further comprising:
sending a test report on the automatic closing function of the landing door to cloud or a mobile terminal.

4. The method of claim 1, further comprising: determining whether the elevator system is adapted to enter or be in a test mode, and if so, performing the steps performing steps A to D.

5. The method of claim 1, wherein the gap is achieved to the preset value by controlling a duration of the driving force applied by the drive mechanism to the car door.

6. The method of claim 1, wherein the preset value satisfies the following conditions:
after the gap of the car door or the gap of the landing door associated with one of the plurality of floors decreases to the preset value, even if the driving force applied to the car door is stopped, the landing door associated with one of the plurality of floors is still capable of being closed normally when the automatic closing function of the landing door is normal.

7. The method of claim 1, wherein the preset time period is determined based on experimental data of a closing operation of the landing door.

8. The method of claim 1, wherein the preset time period is determined in the following manner:
if the driving force or a speed of the car or a speed of the landing door associated with one of the plurality of floors is greater than or equal to a preset threshold, the preset time period is corrected using an inverse function of a Sigmoid function as a correction function.

9. The method of claim 1, wherein a door closing in place signal from the elevator system is used to determine whether the landing door associated with one of the plurality of floors is closed normally.

10. A device for detecting an automatic closing function of a landing door of an elevator system, the device comprising:
a memory;
a processor coupled with the memory; and
a computer program stored on the memory and running on the processor, the running of the computer program resulting in the following operations:
A. when a car of the elevator system stops at one of a plurality of floors, opening a car door of the car and a landing door associated with one of the plurality of floors;
B. initiating a closing process of the car door and the landing door by applying a driving force to the car door by a drive mechanism of the elevator system;
C. causing the drive mechanism to stop applying the driving force to the car door when a gap of the car door or a gap of the landing door decreases to a preset value; and
D. determining whether the landing door can be closed normally within a preset time period since the stopping of applying the driving force to the car door.

11. The device of claim 10, wherein the running of the computer program also causes the further operation:
performing steps A to D in a specified order for landing doors associated with other floors of the plurality of floors.

12. The device of claim 10, wherein the device is an elevator controller.

13. The device of claim 10, wherein the running of the computer program also causes the further operation:
sending a test report on the automatic closing function of the landing door to cloud or a mobile terminal.

14. The device of claim 10, wherein the running of the computer program also causes the further operation:
determining whether the elevator system is adapted to enter or be in a test mode, and if so, performing steps A to D.

15. The device of claim 10, wherein the gap is achieved to the preset value by controlling a duration of the driving force applied by the drive mechanism to the car door.

16. The device of claim 10, wherein the preset value satisfies the following conditions: after the gap of the car door or the landing door associated with one of the plurality of floors decreases to the preset value, even if the driving force applied to the car door is stopped, the landing door associated with one of the plurality of floors is still capable of being closed normally when the automatic closing function of the landing door is normal.

17. The device of claim 10, wherein the preset time period is determined based on experimental data of a closing operation of the landing door.

18. The device of claim 10, wherein the preset time period is determined in the following manner:
if the driving force or a speed of the car or a speed of the landing door associated with one of the plurality of floors is greater than or equal to a preset threshold, the preset time period is corrected using an inverse function of a Sigmoid function as a correction function.

19. The device of claim 10, wherein a door closing in place signal from the elevator system is used to determine whether the landing door associated with one of the plurality of floors is closed normally.

20. An elevator system comprising:
landing doors provided at a plurality of floors having an automatic closing function of a landing door;
a car;
a drive mechanism; and
an elevator controller comprising:
a memory;
a processor coupled with the memory; and
a computer program stored on the memory and running on the processor, the running of the computer program resulting in the following operations:
A. when the car of the elevator system stops at one of the plurality of floors, opening a car door of the car and a landing door associated with one of the plurality of floors;
B. initiating a closing process of the car door and the landing door by applying a driving force to the car door by the drive mechanism of the elevator system;
C. causing the drive mechanism to stop applying the driving force to the car door when a gap of the car door or a gap of the landing door decreases to a preset value; and
D. determining whether the landing door can be closed normally within a preset time period since the stopping of applying the driving force to the car door.

21. A non-transitory computer-readable storage medium, the computer-readable storage medium having instructions stored therein, wherein when the instructions are executed by a processor, the processor performs the method of claim 1.
